(19) United States
(12) Patent Application Publication
(10) Pub. No.: US 2026/0210615 A1
(43) Pub. Date: Jul. 23, 2026

(54) ICEMAKER

(71) Applicant: COWAY CO., LTD., Gongju-si (KR)

(72) Inventors: Kyu Jun KIM, Seoul (KR); Hee Do JUNG, Seoul (KR); Jong Hwan LEE, Seoul (KR); Hee Joo KANG, Seoul (KR); An Ho CHO, Seoul (KR); Byung Hyo YE, Seoul (KR)

(73) Assignee: COWAY CO., LTD., Gongju-si (KR)

(21) Appl. No.: 19/143,175

(22) PCT Filed: Dec. 12, 2023
(86) PCT No.: PCT/KR2023/020451

§ 371 Date: Jun. 25, 2025

(30) Foreign Application Priority Data
Dec. 28, 2022 (KR) 10-2022-0187261

(51) Int. Cl. F25C 5/182; F25C 5/20

(52) U.S. Cl. CPC F25C 5/182; F25C 5/24

(57) ABSTRACT

This icemaker comprises: a storage tank disposed inside a main frame so as to store ice generated by an icemaking unit; a feeder screw that is rotatably disposed in the storage tank and transfers the ice by means of rotation; a coupler assembly that is detachably connected to one side of the feeder screw, is in an engaged state of engaging with one side of the feeder screw when rotated in one direction, and is in a disengaged state of being disengaged from the one side of the feeder screw when rotated in the other direction; and a driving motor driven so as to rotate the coupler assembly in the one direction or the other direction.

### TECHNICAL FIELD

The present disclosure relates to an ice maker.

### BACKGROUND ART

An ice maker is a device that cools water below its freezing point of 0° C. to produce ice and supplies it to a user. Such an ice maker may include an ice-making unit for producing ice, a storage tank for storing ice produced by the ice-making unit, and a feeder screw arranged inside the storage tank. As the usage period of the ice maker increases, the inside of the storage tank may become contaminated, and therefore, the inside of the storage tank needs to be cleaned.

Conventional ice makers have a problem in that the storage tank is fixed inside the ice maker, making it difficult to clean the inside of the storage tank. In other words, due to the internal components of the ice maker, it is hard for the user's hand to reach the inside of the storage tank, making it difficult to clean the inside of the storage tank. In addition, since the feeder screw is formed integrally with the storage tank, even if the user's hand reaches the inside of the storage tank, it is difficult to clean the underside of the feeder screw.

In this regard, Korean Patent Application Publication No. 10-2016-0041874 entitled “Ice Water Purifier” (Patent Document 1), filed by the present applicant, discloses an ice water purifier which allows a user to easily clean the inside by improving the convenience of separating a purified water tank, while disclosing a layout in which a bucket for storing ice and a cold water tank are arranged side by side in the left-right direction and the purified water tank is disposed above them.

However, from Patent Document 1, only the arrangement and separation of the purified water tank are recognized from the perspective of ease of cleaning the cold water tank and the purified water tank, but the necessity of cleaning the bucket where the ice is stored is not recognized. In other words, Patent Document 1 does not disclose that the bucket should be configured to be detachable in order to facilitate cleaning. Therefore, in the ice water purifier of Patent Document 1, there is a problem that it is hard for users to access the internal bucket, and even if the users access the bucket, components such as a screw inside an ice making unit make it difficult to clean the inside of the bucket.

In addition, Korean Patent Application Publication No. 10-2022-0153921 entitled “Ice Maker” (Patent Document 2), filed by the present applicant, discloses an ice making unit, an ice storage unit for storing ice, and an ice transfer unit arranged inside the ice storage unit. Patent Document 2 discloses that the convenience of cleaning an ice tank is improved by arranging an ice making member corresponding to an evaporator of the ice maker in an area outside and directly above the ice storage unit.

However, even in the ice maker of Patent Document 2, a frame cover still has a structure that is difficult to disassemble, making it hard to access the storage tank inside. Further, since the ice storage unit of the ice maker in Patent Document 2 is fixed to a housing assembly of the ice maker, even if the ice making member is positioned away from the area directly above the ice tank, it remains difficult to clean the inside of the ice storage part. In this way, since cleaning the ice storage unit is also difficult in Patent Document 2, there is a need to configure the ice storage unit to be detachable.

In addition, Korean Patent Application Publication No. 10-2014-0113084 entitled “Water Purifier” (Patent Document 3), filed by the applicant LG Electronics Inc., discloses an ice storage unit for storing ice and an auger that is rotatably supported on the ice storage unit. Patent Document 3 discloses an improvement in the convenience of cleaning the ice storage unit by configuring the ice storage unit to be detachable from the front of a main body of a water purifier. The ice storage unit in Patent Document 3 can be separated from the main body of the water purifier by opening an opening/closing part formed on the front surface of the main body of the water purifier. A driving device for rotating the auger of the ice storage unit is disposed at the opening/closing part, and the driving device is configured to be connected to or disconnected from the auger of the ice storage unit by opening or closing the opening/closing part.

However, in Patent Document 3, since the driving device for driving the auger is configured to be supported on the opening/closing part, and the opening/closing part is configured to be detachable from a frame that stores ice by a user's operation, an operational error may occur between the driving device of the opening/closing part and the auger. Therefore, Patent Document 3 has a problem that the driving device and the auger may be inaccurately engaged with each other due to such operational error. Further, since the opening/closing part of Patent Document 3 is opened and closed by the user's manual operation, the connection and disconnection between the driving device and the auger may depend on the user's level of skill in operating it. In other words, when a user who is not skilled in opening and closing the opening/closing part opens or closes the opening/closing part, the driving device and the auger may be inaccurately engaged with each other.

In addition, Korean Patent Application Publication No. 10-2014-0106331 entitled “Ice water purifier and ice hot/cold water dispenser including a detachable ice storage container” (Patent Document 4), filed by the applicant Hwi-dong JUNG, discloses an ice storage container for storing ice, an ice transfer member disposed inside the ice storage container, and a motor for rotating the ice transfer member. Further, Patent Document 4 discloses that the ice storage container is configured to be detachable toward the front of the ice water purifier, thereby improving the convenience of cleaning the ice storage container.

However, Patent Document 4 discloses only that a motor is arranged at the front side of the ice storage container and that the ice storage container is detachable in the front-rear direction of the ice water purifier, but does not disclose that the ice transfer member can be detached from the motor to allow a user to insert the hand into the ice storage container for cleaning. In other words, in Patent Document 4, only the simple detachment of the ice storage container is recognized, and the ice transfer member is not detached even when the ice storage container is detached from the case, so that it may be inconvenient to clean it.

In addition, as in Korean Patent Application Publication No. 10-2021-0147419 entitled “Ice Water Purifier” (Patent Document 5), filed by the present applicant, when the ice maker is configured such that other components are arranged in front of the ice storage unit, it becomes difficult to configure the ice storage unit to be detachable in the front-rear direction due to the presence of the front-side components. Accordingly, it is necessary to change the detachment direction of the ice storage unit so that the ice storage unit could be removed laterally from the ice water purifier. However, the lateral removal of the ice storage unit from the ice water purifier is restricted due to a screw member arranged inside the ice storage unit. In other words, as in Patent Document 5, since the screw member is arranged inside the ice storage unit and the screw member is connected to a drive motor to be rotated thereby, which makes it difficult to detach the ice storage unit from the main body of the ice water purifier. Therefore, in such a structure, in order for the ice storage unit to be removed laterally from the ice water purifier, the screw member inside the ice storage unit needs to be removed first.

### PRIOR ART DOCUMENT

### Patent Document

Patent Document 1: Korean Patent Application Publication No. 10-2016-0041874 (published on Aug. 23, 2013)

Patent Document 2: Korean Patent Application Publication No. 10-2022-0153921 (published on Nov. 21, 2022)

Patent document 3: Korean Patent Application Publication No. 10-2014-0113084 (published on Sep. 24, 2014)

Patent Document 4: Korean Patent Application Publication No. 10-2014-0106331 (published on Sep. 3, 2014)

Patent document 5: Korean Patent Application Publication No. 10-2021-0147419 (published on Dec. 7, 2021)

### DETAILED DESCRIPTION OF INVENTION

### Technical Problems

Embodiments of the present disclosure have been devised in view of the aforementioned background, and provide an ice maker in which a storage tank can be easily detached from a main frame of the ice maker.

In addition, the embodiments of the present disclosure provide an ice maker in which a feeder screw is configured to be easily removed from the storage tank, so that the storage tank can be removed laterally from the ice maker without interference with other components of the ice maker.

### Technical Solution

In accordance with one embodiment of the present disclosure, an ice maker comprises: a storage tank, disposed inside a main frame, storing ice produced by an ice making unit, a feeder screw rotatably disposed in the storage tank and conveying the ice by rotation; a coupler assembly detachably connected to one side of the feeder screw, wherein when rotated in one direction, the coupler assembly may be in an engaged state where the coupler assembly is engaged with the one side of the feeder screw, and when rotated in the other direction, the coupler assembly may be in a disengaged state where the coupler assembly is not engaged with the one side of the feeder screw; and a drive motor operated to rotate the coupler assembly in the one direction or the other direction.

Further, the coupler assembly may include: a first coupler which is rotated by the drive motor and has a first protrusion/recess formed on an outer peripheral surface thereof; and a second coupler which has a second protrusion/recess formed on an inner surface thereof to be engaged with the first protrusion/recess of the first coupler, the second coupler being coupled to the first coupler by an engagement between the first protrusion/recess and the second protrusion/recess, and wherein the first coupler and the second coupler may be configured such that the first coupler and the second coupler rotate together, or the first coupler is rotatable in a state where the rotation of the second coupler is restricted.

Further, the ice maker may further comprise a stopper which is placed in a rotation-restricting position that restricts a rotation of the second coupler or in a rotation-permitting position that permits the rotation of the coupler, wherein the second coupler may include a protruding rib that engages with the stopper when the drive motor rotates in the one direction while the stopper is in the rotation-restricting position, and the rotation of the coupler may be restricted by the engagement between a protruding rib and the stopper while the stopper is in the rotation-restricting position.

Further, in a state where the coupler assembly may be in the disengaged state and the stopper may be placed in the rotation-restricting position, when the first coupler is rotated in the one direction, the rotation of the coupler may be restricted by the engagement between the protruding rib and the stopper, and the second coupler is moved along the first coupler to approach the feeder screw, thereby switching the coupler assembly from the disengaged state to the engaged state, and wherein in a state where the coupler assembly may be in the engaged state and the stopper may be placed in the rotation-restricting position, when the first coupler is rotated in the other direction, the rotation of the coupler may be restricted by the engagement between the protruding rib and the stopper, and the second coupler is moved along the first coupler away from the feeder screw, thereby switching the coupler assembly from the engaged state to the disengaged state.

Further, when the coupler assembly may be in the engaged state, the coupler assembly rotates in the one direction, thereby causing the feeder screw to discharge the ice to the outside of the storage tank.

Further, the ice maker further comprise an opening/closing door configured to open to discharge ice stored in the storage tank to the outside, wherein the stopper may be disposed on the opening/closing door, and wherein when the opening/closing door is opened, the stopper may be placed in the rotation-permitting position.

Further, the first protrusion/recess may have a screw shape extending in a right-hand thread direction or a left-hand thread direction, the second protrusion/recess may have a screw shape engaging with the first protrusion/recess, and the feeder screw may include a conveying blade having a screw shape extending in a direction opposite to that of the first protrusion/recess.

Further, the second coupler may be formed with a coupler engagement portion having a groove shape, and the feeder screw may include a screw engagement portion which is formed on the one side and which engages with the coupler engagement portion when the coupler assembly is in the engaging state, thereby preventing relative rotation between the feeder screw and the coupler assembly.

Further, the screw engagement portion may have a shape with narrower width as it extends toward an end, and the coupler engagement portion may have a tapered shape that is inclined outward.

Further, the storage tank may be formed with an attachment/detachment hole in which the feeder screw is selectively fixed, the feeder screw may include a magnetic body disposed on the other side of the feeder screw, and the other side of the feeder screw may adhere to the storage tank by the magnetic body inserted into the attachment/detachment hole.

### Effect of Invention

According to the embodiments of the present disclosure, the coupler assembly that transmits rotational force to the feeder screw disposed inside the storage tank and the feeder screw are configured to be detachably engaged, so that the storage tank can be removed from the main frame of the ice maker without interference from the feeder screw, and a user can easily clean the inside of the storage tank while it is detached from the ice maker.

Further, according to the embodiments of the present disclosure, the feeder screw can be separated in conjunction with the operation of the door.

Furthermore, according to the embodiments of the present disclosure, in the coupler assembly, the first coupler and the second coupler are coupled by the engagement between the first protrusion/recess of the first coupler and the second protrusion/recess of the second coupler, so that the second coupler can be rotated by the rotation of the first coupler while the first coupler and the second coupler are firmly coupled.

In addition, according to the embodiments of the present disclosure, the first coupler rotates while the rotation of the second coupler is restricted by the stopper, so that the coupler assembly and the feeder screw can be selectively engaged or disengaged by the rotation of the feeder screw.

Further, according to the embodiments of the present disclosure, by disposing the stopper on the opening/closing door, the rotation of the second coupler can be restricted or allowed by the opening or closing of the opening/closing door.

Furthermore, according to the embodiments of the present disclosure, the conveying blades of the feeder screw are formed in the direction opposite to the screw of the first protrusion/recess, and the feeder screw rotates in the direction of discharging ice inside the storage tank, so that the feeder screw can rotate in the direction that reinforces the coupling between the first coupler and the second coupler and convey the ice to the outside of the storage tank.

In addition, according to the embodiments of the present disclosure, the screw engagement portion has a shape with narrower width as it extends toward an end, and the coupler engagement portion has a tapered shape that is inclined outward, so that the screw engagement portion and the coupler engagement portion can easily engage with each other.

In addition, according to the embodiments of the present disclosure, the magnetic body of the feeder screw is configured to be selectively secured in the attachment/detachment hole in the storage tank, so that the feeder screw can remain inserted in the attachment/detachment hole even when the feeder screw is separated from the coupler assembly.

### BRIEF DESCRIPTION OF THE DRAWINGS

FIG. 1 is a front view of an ice maker according to one embodiment of the present disclosure.

FIG. 2 is a perspective view of the ice maker according to one embodiment of the present disclosure.

FIG. 3 is an exploded perspective view of the ice maker according to one embodiment of the present disclosure as viewed from the front side.

FIG. 4 is an enlarged view of part A in FIG. 5 of the present disclosure.

FIG. 5 is a diagram showing a storage tank, a feeder screw, a coupler assembly, and a drive motor of the ice maker according to one embodiment of the present disclosure.

FIG. 6 is an exploded perspective view of the ice maker according to one embodiment of the present disclosure as viewed from the rear side.

FIG. 7 is a partially exploded perspective view of the coupler assembly and the drive motor of the ice maker according to one embodiment of the present disclosure.

FIGS. 8 to 11 are diagrams showing the operating states of the coupler assembly and the feeder screw of the ice maker according to one embodiment of the present disclosure.

### MODE FOR CARRYING OUT THE INVENTION

Hereinafter, specific embodiments for implementing the technical idea of the present disclosure will be described in detail with reference to the drawings.

In addition, in describing the present disclosure, when it is determined that detailed descriptions of known configurations or functions may obscure the gist of the present disclosure, the detailed descriptions will be omitted.

Moreover, it should be understood that when a component is referred to as being ‘connected to’, ‘supported by’, ‘supplied to’, ‘conveyed to’, or ‘contacted with’ another component, it may be directly connected to, supported by, supplied to, conveyed to, or contacted with another component, but other components may exist between the components.

The terms used in the present specification are only used for describing the specific embodiments and are not intended to limit the present disclosure. Singular expressions include plural expressions unless the context clearly indicates otherwise.

In addition, in the present specification, expressions such as upper, lower, side, etc. are described based on the drawings, and it is made clear in advance that they may be expressed differently if the direction of the object is changed. For the same reason, some components in the accompanying drawings are exaggerated, omitted, or schematically illustrated, and the size of each component does not entirely reflect the actual size.

Further, terms including ordinal numbers, such as first, second, etc., may be used to describe various components, but the components are not limited by these terms. These terms are only used to distinguish one component from another.

The meaning of “including” used in the present specification specifies specific features, regions, integers, steps, operations, elements and/or components, and does not exclude the presence or addition of other specific features, regions, integers, steps, operations, elements, components, and/or groups.

Hereinafter, a specific configuration of an ice maker 10 according to one embodiment of the present disclosure will be described with reference to the drawings.

The ice maker 10 according to one embodiment of the present disclosure may be a device that produces ice and provides it to a user. The ice maker 10 may include a main frame 11, a main cover 12, a storage tank 100, a feeder screw 200, a coupler assembly 300, a drive motor 400, an opening/closing door 500, a stopper 600, an ice making unit 700, a filter 800, a flow channel (not shown), a valve module (not shown), and a controller 900.

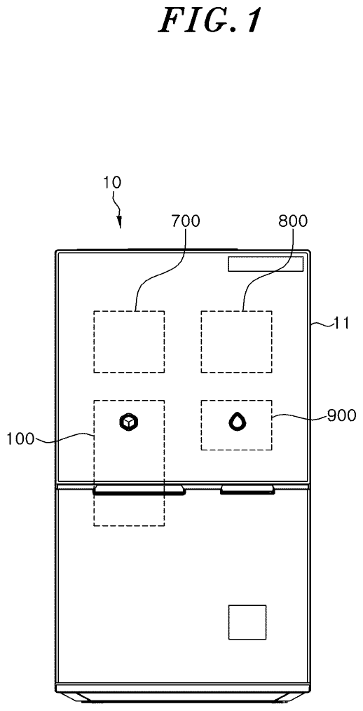

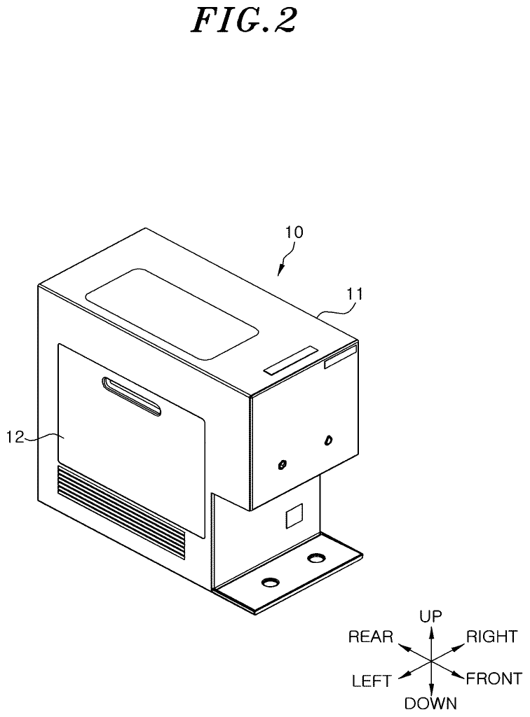

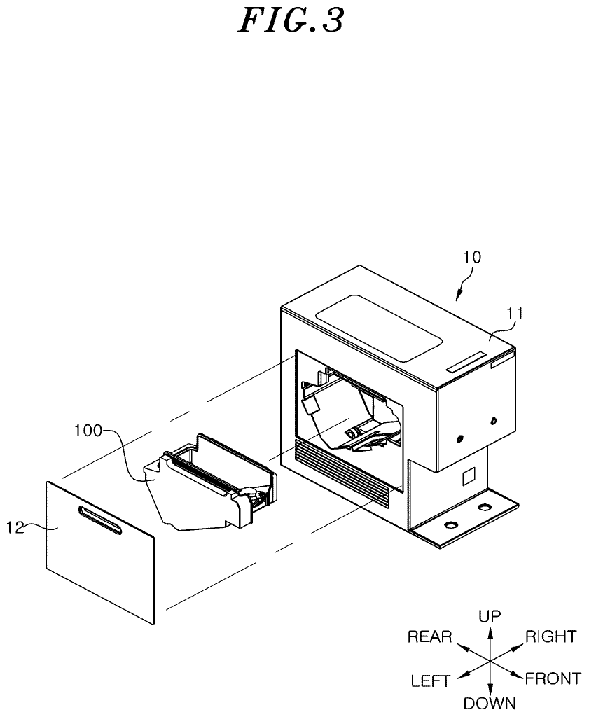

Referring to FIGS. 1 to 3, the main frame 11 forms the overall appearance of the ice maker 10 and may support one or more of the main cover 12, the storage tank 100, the feeder screw 200, the coupler assembly 300, the drive motor 400, the opening/closing door 500, the stopper 600, the ice making unit 700, the filter 800, the flow channel, the valve module, and the controller 900. The main frame 11 may extend in an up-down direction and may have a shape in which a portion of the upper section protrudes forward. The main frame 11 may provide an accommodation space for accommodating one or more of the main cover 12, the storage tank 100, the feeder screw 200, the coupler assembly 300, the drive motor 400, the opening/closing door 500, the stopper 600, the ice making unit 700, the filter 800, the flow channel, the valve module, and the controller 900.

The accommodation space of the main frame 11 may include a tank accommodation space for accommodating the storage tank 100. The tank accommodation space may be formed to extend inward from the left or the right side of the main frame 10. In other words, the tank accommodation space may be open toward the left or the right side of the main frame 10. The tank accommodation space may be formed in a shape corresponding to the outer shape of the storage tank 100, and the storage tank 100 can be inserted into the tank accommodation space and supported by the main frame 11.

The main cover 12 may be detachably fixed to the main frame 11 to cover the open left or right side of the main frame 11. The main cover 12 may be fixed to the open left or right side of the main frame 11 to prevent the storage tank 100, the coupler assembly 300, the drive motor 400, the opening/closing door 500, and the stopper 600 arranged inside the main frame 11 from being externally exposed. In other words, the main cover 12 may form a part of the outer appearance of the ice maker 10 by covering the open left or right side of the main frame 11.

The storage tank 100 may provide an ice storage space for storing ice produced in the ice making unit 700. The outer shape of the storage tank 100 may correspond to the shape of the tank accommodation space of the main frame 11, and the storage tank 100 can be inserted into the tank accommodation space of the main frame 11. In addition, a lower portion of the storage tank 100 may be formed such that its length in a front-rear direction increases from the bottom to the top. In other words, a storage area of the ice storage space of the storage tank 100 may become wider from the bottom to the top.

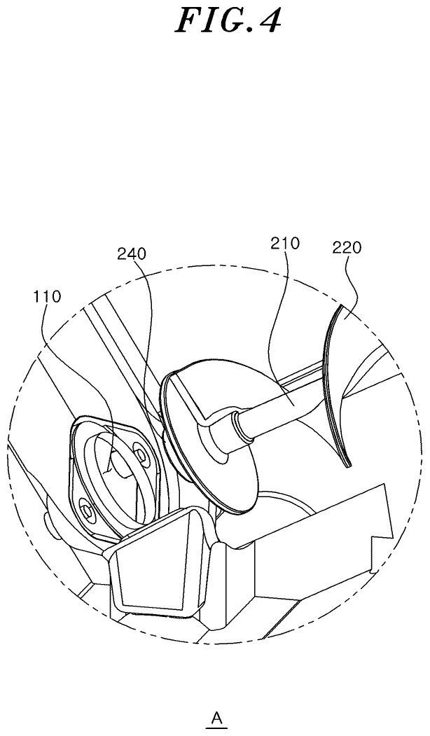

Referring to FIG. 4, an attachment/detachment hole 110 may be formed inside the storage tank 100. The attachment/detachment hole 110 may be positioned on an inner surface of the rear side of the storage tank 100. A magnetic body 240 of the feeder screw 200, which will be described later, may be inserted into the attachment/detachment hole 110. By inserting the magnetic body 240 of the feeder screw 200 into the attachment/detachment hole 110, the feeder screw 200 can be supported by the storage tank 100. The attachment/detachment hole 110 may be formed of a metallic material for coupling with the magnetic body 240.

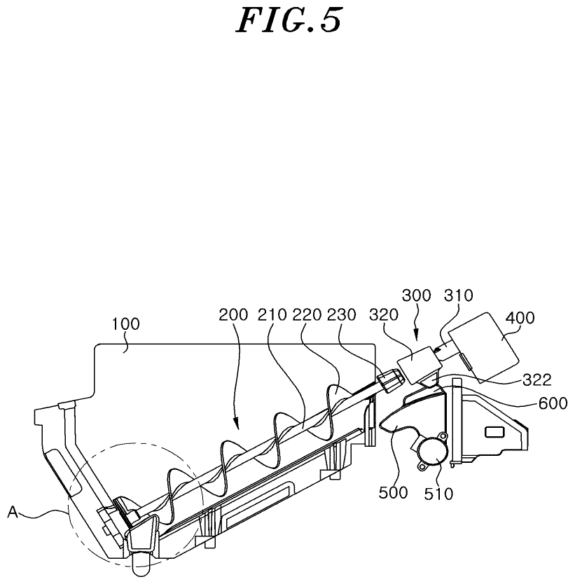

Referring to FIG. 5, the feeder screw 200 may be disposed inside the storage tank 100 and can transfer ice stored in the storage tank 100 to discharge it to the outside of the storage tank 100. The feeder screw 200 may include a screw shaft 210, a conveying blade 220, a screw engagement portion 230, and a magnetic body 240.

The screw shaft 210 may be formed to extend in the front-rear direction of the storage tank 100 and may be arranged in the front-rear direction in the storage tank 100. The screw shaft 210 may be supported by the storage tank 100 to be rotatable. The screw shaft 210 can be rotated clockwise or counterclockwise.

The conveying blade 220 is supported by the screw shaft 210 and can be rotated together with the screw shaft 210 to convey ice. The conveying blade 220 may be a screw that extends along the screw shaft 210 in a right-hand thread direction or a left-hand thread direction. The conveying blade 220 may be a screw that is formed in a direction opposite to that of a first protrusion/recess 311 of the coupler assembly 300, which will be described later. For example, when the first protrusion/recess 311 of the coupler assembly 300 is formed in a right-hand thread direction, the conveying blade 220 may be formed in a left-hand thread direction, and when the first protrusion/recess 311 of the coupler assembly 300 is formed in a left-hand thread direction, the conveying blade 220 may be formed in a right-hand thread direction.

The screw engagement portion 230 may be disposed on one side of the screw shaft 210 to be releasably engaged with the coupler assembly 300, which will be described later. In this case, one side of the screw shaft 210 may be the front end of the screw shaft 210, and the other side of the screw shaft 210 may be the rear end of the screw shaft 210. One side of the screw shaft 210 may be extended to protrude outward from the front side of the storage tank 100. The screw engagement portion 230 may have a shape with narrower width as it extends outward from the front side of the storage tank 100.

The magnetic body 240 can provide a magnetic force to adhere to the storage tank 100. The magnetic body 240 may be formed on the other side of the screw shaft 210 to be inserted into the attachment/detachment hole 110 of the storage tank 100. The magnetic body 240 adheres to the attachment/detachment hole 110 of the storage tank 100 through the magnetic force while inserted into the attachment/detachment hole 110 of the storage tank 100, so that the other side of the feeder screw 200 can be prevented from being arbitrarily detached from the attachment/detachment hole 110. In other words, even when the engagement between the feeder screw 200 and the coupler assembly 300 is released, the other side of the screw shaft 210 can be maintained in the state of being inserted into the attachment/detachment hole 110 by the magnetic force of the magnetic body 240. In this way, when the feeder screw 200 is disengaged from the coupler assembly 300, one side of the feeder screw 200 may sag downward due to the weight of the feeder screw 200 itself, but since the feeder screw 200 is secured to the attachment/detachment hole 110 by the magnetic body 240, it can maintain a posture facing the coupler assembly 300. Accordingly, even when the feeder screw 200 and the coupler assembly 300 come closer to each other from a state where the feeder screw 200 and the coupler assembly 300 are spaced apart from each other so that the engagement between the feeder screw 200 and the coupler assembly 300 is released, since the feeder screw 200 is secured to the attachment/detachment hole 110 by the magnetic body 240, the feeder screw 200 and the coupler assembly 300 can be engaged with each other even when the user does not hold the feeder screw 200. Meanwhile, the user can separate the feeder screw 200 from the storage tank 100 by applying an external force greater than the magnetic force of the magnetic body 240 to the feeder screw 200.

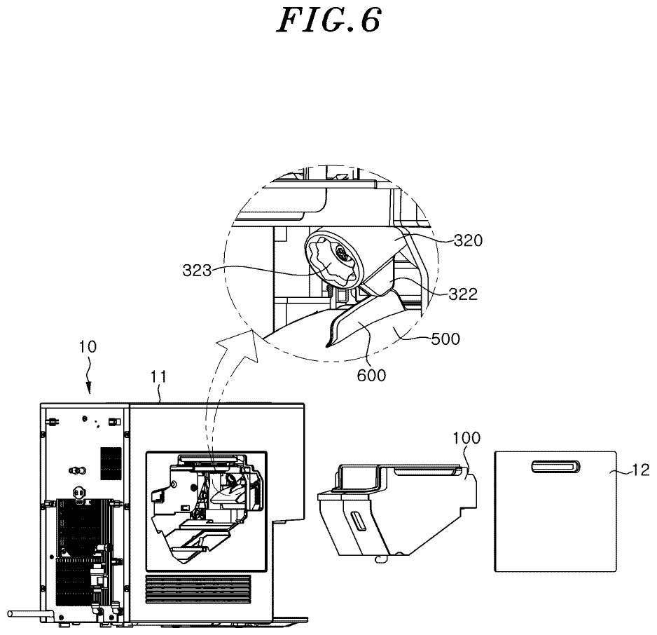

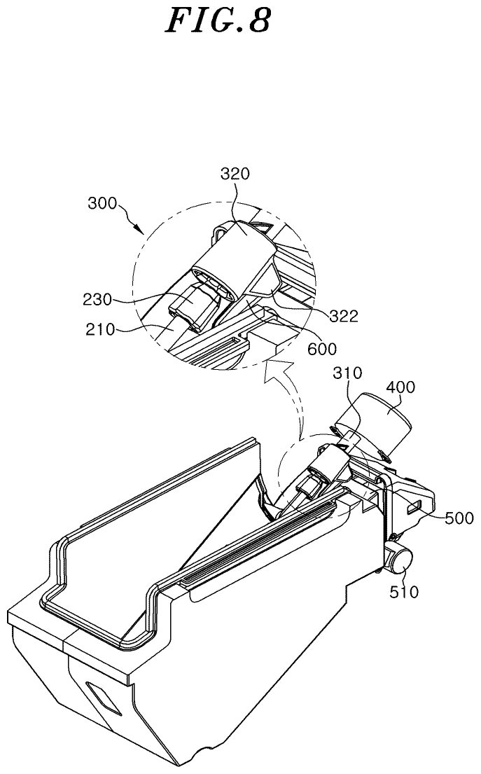

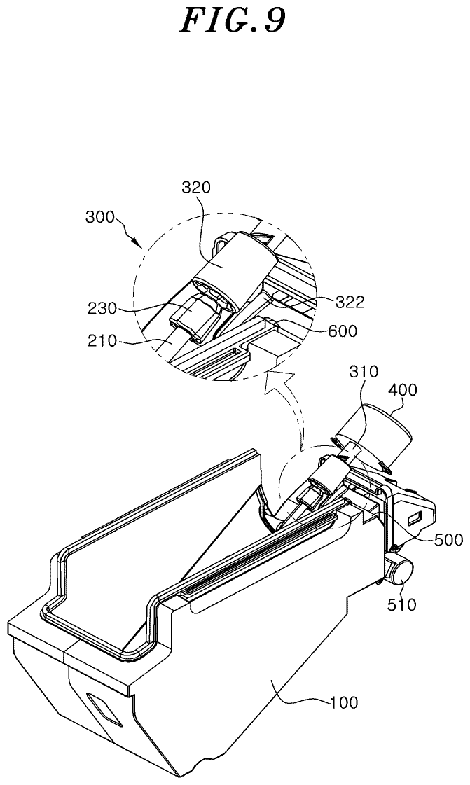

Referring to FIGS. 5 to 9, the coupler assembly 300 may be selectively engaged with or disengaged from the screw engagement portion 230 disposed on one side of the feeder screw 200. The coupler assembly 300 may be disposed on the front side in the main frame 11. The coupler assembly 300 may include a first coupler 310 and a second coupler 320.

The first coupler 310 can be rotated by a drive shaft 410 of the drive motor 400, which will be described later. The first coupler 310 may be arranged coaxially with the screw shaft 210 of the feeder screw 200 and the drive shaft 410 of the drive motor 400. The first coupler 310 can be rotated about an axis extending in a direction parallel to the screw shaft 210 of the feeder screw 200 as the rotation center. The first protrusion/recess 311 may be formed on an outer peripheral surface of the first coupler 310.

The first protrusion/recess 311 may be formed on the outer peripheral surface of the first coupler 310 to extend along the longitudinal direction of the first coupler 310. For example, the first protrusion/recess 311 may be formed in a screw shape extending in a right-hand thread direction or a left-hand thread direction. In addition, the first protrusion/recess 311 may take the form of both a groove and a protrusion, but may also take the form of either a groove or a protrusion.

The second coupler 320 can be rotated together with the first coupler 310 or moved forward or backward along the longitudinal direction of the first coupler 310. The second coupler 320 may be arranged coaxially with the first coupler 310 and may also be arranged coaxially with the drive shaft 410 of the drive motor 400. The second coupler 320 can be rotated about an axis extending in a direction parallel to the screw axis 210 of the feeder screw 200. On an inner surface of the second coupler 320, a connecting groove may be formed to allow engagement with the first coupler 310, and a second protrusion/recess 321 that engages with the first protrusion/recess 311 of the first coupler 310 may be formed on an inner surface of the connecting groove. In addition, a protruding rib 322 and a coupler engagement portion 323 may be formed on the second coupler 320.

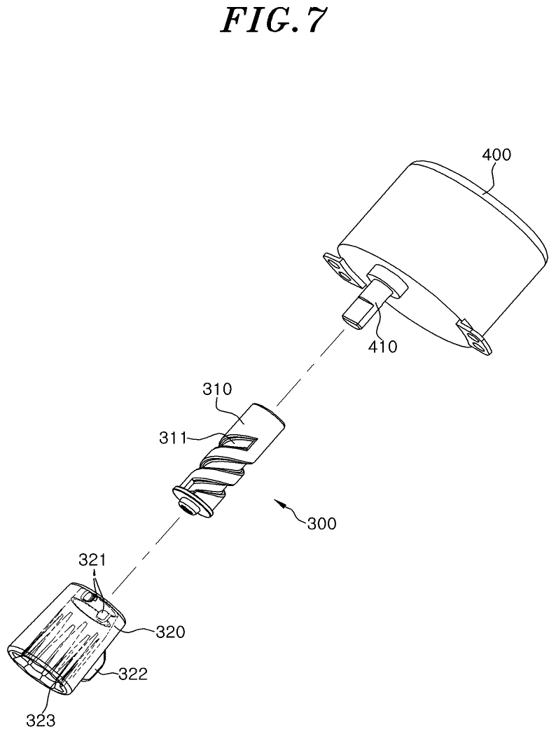

The second protrusion/recess 321 may be formed to extend along the longitudinal direction of the second coupler 320 on the inner surface of the connecting groove of the second coupler 320. For example, as shown in FIG. 7, the second protrusion/recess 321 may be a pair of protrusions formed at opposing positions to be engaged with the groove of the first protrusion/recess 311. In addition, the shape of the second protrusion/recess 321 is not limited to the shape of a pair of protrusions, and may be formed in a screw shape corresponding to the first protrusion/recess 311. In other words, when the first protrusion/recess 311 is formed in a right-hand thread direction, the second protrusion/recess 321 may also be formed in the right-hand thread direction, and when the first protrusion/recess 311 is formed in a left-hand thread direction, the second protrusion/recess 321 may also be formed in the left-hand thread direction. Further, the second protrusion/recess 321 may take the form of a groove and/or a protrusion.

The protruding rib 322 can limit the rotation of the second coupler 320 by coming into contact with the stopper 600, which will be described later. The protruding rib 322 may be formed to extend outward from an outer peripheral surface of the second coupler 320 and may be shaped to extend along the longitudinal direction of the second coupler 320. The protruding rib 322 may protrude toward the opening/closing door 500.

The coupler engagement portion 323 can be selectively engaged with the screw engagement portion 230 of the feeder screw 200. The coupler engagement portion 323 may have a groove shape recessed inward from the inner surface of the second coupler 320. The coupler engagement portion 323 may be formed on the inner surface of the second coupler 320, facing the screw engagement portion 230. The coupler engagement portion 323 may be formed in a tapered shape, inclined outward toward the feeder screw 200. In other words, since the screw engagement portion 230 is formed in the shape with narrower width as it extends away from the feeder screw 200, the coupler engagement portion 323 that engages with the screw engagement portion 230 may be formed to be inclined outward toward the feeder screw 200.

The second coupler 320 and the feeder screw 200 may be in an engaged state in which the coupler engagement portion 323 of the second coupler 320 and the screw engagement portion 230 of the feeder screw 200 are engaged with each other, or in a disengaged state in which the engagement between the coupler engagement portion 323 of the second coupler 320 and the screw engagement portion 230 of the feeder screw 200 is released.

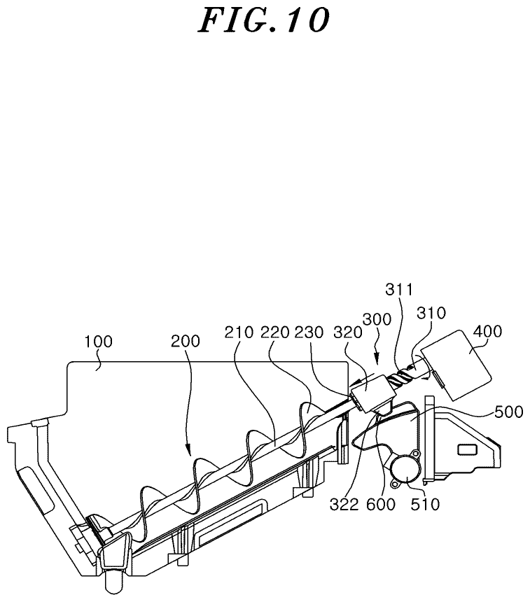

Referring further to FIG. 10, when the protruding rib 322 comes into contact with the stopper 600 in the disengaged state and the rotation of the second coupler 320 is restricted, when the drive shaft 410 of the drive motor 400 is operated to rotate in one direction, the first coupler 310 connected to the drive shaft 410 may also rotate in one direction. When the first coupler 310 is rotated in one direction, the rotation of the second coupler 320 is restricted by the contact between the protruding rib 322 and the stopper 600, so that the second coupler 320 may move toward the screw engagement portion 230 along the longitudinal direction of the first coupler 310. In other words, the second coupler 320 is pushed toward the screw engagement portion 230 by the relative rotation of the first coupler 310 with respect to the second coupler 320, and the coupler engagement portion 323 and the screw engagement portion 230 may be engaged with each other.

When the first coupler 310 is rotated in one direction and the coupler engagement portion 323 and the screw engagement portion 230 are completely engaged, the rotation of the first coupler 310 relative to the second coupler 320 in one direction is no longer permitted. In other words, when the drive motor 400 rotates in a state where the coupler engagement portion 323 and the screw engagement portion 230 are completely engaged, the feeder screw 200 and the coupler assembly 300 are operated to rotate together.

The drive motor 400 may provide rotational force to the feeder screw 200 and the coupler assembly 300. The drive motor 400 may be disposed at the front side in the accommodation space of the main frame 11. The drive shaft 410 of the drive motor 400 may rotate the feeder screw 200 by rotating while being connected to the screw shaft 210 of the feeder screw 200 through the coupler assembly 300.

In this case, when the first protrusion/recess 311 and the second protrusion/recess 321 are formed in a left-hand thread direction, the one direction in which the drive shaft 410 rotates may be clockwise when viewing the drive shaft 410 from the drive motor 400 side. In other words, when the drive shaft 410 rotates in the one direction, in order for the second coupler 320 to move toward the screw engagement portion 230 along the longitudinal direction of the first coupler 310, the engagement between the first protrusion/recess 311 and the second protrusion/recess 321 should be released, and therefore the one direction in which the drive shaft 410 rotates may be clockwise when viewing the drive shaft 410 from the drive motor 400 side. In case that the first protrusion/recess 311 and the second protrusion/recess 321 are formed in a right-hand thread direction, the one direction in which the drive shaft 410 rotates may be counterclockwise when viewing the drive shaft 410 from the drive motor 400 side. In addition, the one direction in which the drive shaft 410 rotates may correspond to the rotation direction of the feeder screw 200, which conveys ice to the outside of the storage tank 100.

When the protruding rib 322 comes into contact with the stopper 600 in the engaged state and the rotation of the second coupler 320 is restricted, if the drive shaft 410 of the drive motor 400 is operated to rotate in the other direction, the first coupler 310 connected to the drive shaft 410 may also rotate in the other direction. When the first coupler 310 is rotated in the other direction, the rotation of the second coupler 320 is restricted by the contact between the protruding rib 322 and the stopper 600, and thus the second coupler 320 may move away from the screw engagement portion 230 along the longitudinal direction of the first coupler 310. In other words, the second coupler 320 moves away from the screw engagement portion 230 by the relative rotation of the first coupler 310 with respect to the second coupler 320, so that the engagement between the coupler engagement portion 323 and the screw engagement portion 230 is released, which allows the second coupler 320 and the feeder screw 200 to be in the disengaged state.

In this case, when the first protrusion/recess 311 and the second protrusion/recess 321 are formed in a left-hand thread direction, the other direction in which the drive shaft 410 rotates may be counterclockwise when viewing the drive shaft 410 from the drive motor 400 side. In other words, when the drive shaft 410 rotates in the other direction, in order for the second coupler 320 to move away from the screw engagement portion 230 along the longitudinal direction of the first coupler 310, the first protrusion/recess 311 and the second protrusion/recess 321 should engage each other, and therefore, the other direction in which the drive shaft 410 rotates may be counterclockwise when viewing the drive shaft 410 from the drive motor 400 side. In case that the first protrusion/recess 311 and the second protrusion/recess 321 are formed in a right-hand thread direction, the other direction in which the drive shaft 410 rotates may be clockwise when viewing the drive shaft 410 from the drive motor 400 side.

The opening/closing door 500 can be opened to allow the interior of the storage tank 100 and the exterior of the ice maker 10 to communicate with each other, thereby providing a discharge path for ice stored in the storage tank 100 to be discharged to the outside of the ice maker 10. The opening/closing door 500 may be disposed at the front side in the accommodation space of the main frame 11, and may be arranged adjacent to the front side of the storage tank 100. The opening/closing door 500 can be rotated by a rotation motor 510, and can be opened or closed by the rotation.

The stopper 600 can restrict or permit the rotation of the second coupler 320 by being placed in a rotation-restricting position that restricts the rotation of the second coupler 320 or in a rotation-permitting position that permits the rotation of the second coupler 320. When the stopper 600 is placed in the rotation-restricting position and the second coupler 320 rotates, the stopper 600 can interfere with the protruding rib 322 of the second coupler 320 and restrict the rotation of the second coupler 320. In addition, when the stopper 600 is placed in the rotation-permitting position and the second coupler 320 rotates, the stopper 600 does not interfere with the protruding rib 322 of the second coupler 320, thereby allowing the rotation of the second coupler 320. The stopper 600 may be disposed on the opening/closing door 500. The stopper 600 may have a protrusion shape extending upward from an upper portion of the opening/closing door 500.

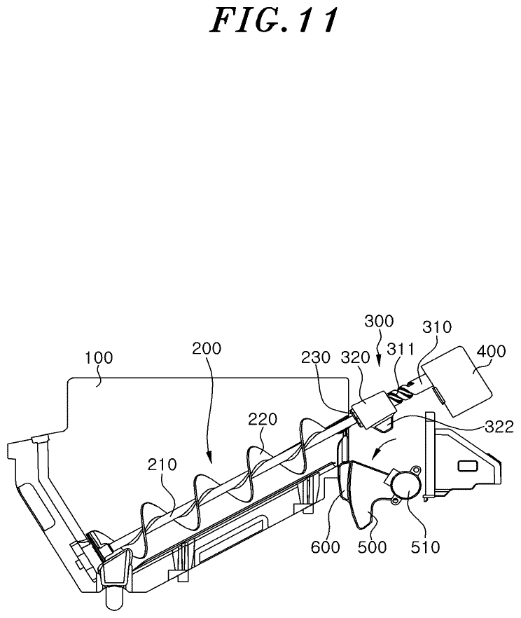

Referring to FIGS. 10 and 11, when the stopper 600 is disposed on the opening/closing door 500, it can be placed in the rotation-restricting position or the rotation-permitting position depending on the movement of the opening/closing door 500. When the opening/closing door 500 is closed to block the ice discharge path, the stopper 600 can be placed in the rotation-restricting position and come into contact with the protruding rib 322 to restrict the rotation of the second coupler 320. When the stopper 600 is placed in the rotation-restricting position and the first coupler 310 rotates, the second coupler 320 can be moved forward or backward along the longitudinal direction of the first coupler 310 without rotating.

Meanwhile, when the opening/closing door 500 opens the ice discharge path, the stopper 600 is placed in the rotation-permitting position and does not come into contact with the protruding rib 322, thereby allowing the rotation of the second coupler 320. When the stopper 600 is in the rotation-permitting position, the coupler engagement portion 323 and the screw engagement portion 230 can be completely engaged, and the feeder screw 200 can be rotated by the coupler assembly 300. As the feeder screw 200 is rotated by the coupler assembly 300, ice stored inside the storage tank 100 can be discharged to the outside of the storage tank 100. Only when the coupler engagement portion 323 of the second coupler 320 and the screw engagement portion 230 of the feeder screw 200 are engaged with each other, the opening/closing door 500 can be opened and the stopper 600 can be placed in the rotation-permitting position.

The ice making unit 700 can cool water supplied to the ice maker 10 to produce ice. The ice making unit 700 may be disposed inside the main frame 11. The ice making unit 700 may be disposed above the storage tank 100 to supply the produced ice to the storage tank 100.

The filter 800 can filter raw water supplied from the outside into the ice maker 10 to provide purified water. The filter 800 may be disposed inside the main frame 11. The purified water filtered by the filter 800 can be delivered to the ice making unit 700 to become ice, or can be discharged to the outside of the ice maker 10 to be provided to a user. The purified water filtered by the filter 800 may include one or more of hot water, cold water, and water that is filtered but neither heated nor cooled.

The flow channel can provide a passage through which raw water and purified water flow. The flow channel may include a raw water flow path and a purified water flow path.

The raw water flow path can provide a passage through which raw water discharged from a raw water supply source flows. In addition, the raw water flow path may be connected to the filter 800. The raw water can flow to the filter 800 through the raw water flow path.

The purified water flow path can provide a passage through which purified water discharged from the filter 800 flows. In addition, the purified water flow path may be connected to a purified water outlet that dispenses purified water to the outside of the ice maker 10. Through the purified water flow path, purified water discharged from the filter 800 can flow to the purified water outlet to be dispensed to the outside of the ice maker 10.

The valve module may be provided as a plurality of valve modules that are selectively opened and closed to control the flow of raw water and purified water in the flow channel. The plurality of valve modules may include a first valve module and a second valve module. The first valve module may be provided in the raw water flow path and may be opened and closed to allow the raw water to flow into the filter 800. The second valve module may be provided in the purified water flow path and may be opened and closed to allow purified water discharged from the filter 800 to flow to the purified water outlet.

The controller 900 can control one or more of the drive motor 400, the opening/closing door 500, and the ice making unit 700. In addition, the controller 900 can control the valve modules arranged in the internal flow channel so that water or ice is dispensed to the outside of the ice maker 10 according to a user's operation. The controller 900 may be implemented by a computing device including a microprocessor, and the implementation method thereof is obvious to those skilled in the art, so a detailed description thereof will be omitted.

Hereinafter, with reference to FIGS. 5, 10, and 11, the operating state of the ice maker 10 according to one embodiment of the present disclosure will be described.

Referring to FIG. 5, when a user presses an ice dispensing lever of the ice maker 10 before extracting ice from the ice maker 10, the drive motor 400 operates so that the drive shaft 410 is rotated in one direction, and the coupler assembly 300 connected to the drive shaft 410 is also rotated in the one direction. When the coupler assembly 300 rotates in the one direction and the protruding rib 322 of the second coupler 320 comes into contact with the stopper 600, the rotation of the second coupler 320 is restricted.

Referring to FIG. 10, when the drive motor 400 continues to operate so that the drive shaft 410 rotates in the one direction while the rotation of the second coupler 320 is restricted, the second coupler 320 moves toward the screw engagement portion 230 along the longitudinal direction of the first coupler 310, so that the coupler engagement portion 323 of the second coupler 320 and the screw engagement portion 230 of the feeder screw 200 are engaged with each other.

Referring to FIG. 11, in the state where the coupler engagement portion 323 of the second coupler 320 and the screw engagement portion 230 of the feeder screw 200 are engaged with each other, the opening/closing door 500 is rotated by the operation of the rotation motor 510 to open the discharge path through which ice is discharged to the outside of the ice maker 10. When the stopper 600 is placed in the rotation-permitting position by the opening of the opening/closing door 500, the coupler assembly 300 can be rotated. When the coupler assembly 300 is rotated, the feeder screw 200 connected to the coupler assembly 300 is rotated, so that ice stored inside the storage tank 100 can be discharged to the outside of the ice maker 10 through the discharge path.

When the discharge of ice to the outside of the ice maker 10 is completed, the opening/closing door 500 closes the discharge path, and the stopper 600 is placed in the rotation-restricting position. When the stopper 600 is placed in the rotation-restricting position, the rotation of the second coupler 320 can be restricted. In the state where the rotation of the second coupler 320 is restricted, when the drive motor 400 is operated such that the drive shaft 410 rotates in the other direction, the second coupler 320 moves toward the drive motor 400 along the longitudinal direction of the first coupler 310, and the engagement between the coupler engagement portion 323 of the second coupler 320 and the screw engagement portion 230 of the feeder screw 200 is released.

Hereinafter, the operation and effects of the ice maker 10 according to one embodiment of the present disclosure will be described.

The coupler assembly 300, which transmits rotational force to the feeder screw 200 that is disposed inside the storage tank 100 and conveys ice to the outside of the ice maker 10, is configured to selectively engage with the feeder screw 200, so that the storage tank 100 can be removed from the main frame 11 of the ice maker 10 without interference from the coupler assembly 300. Since the storage tank 100 can be removed from the main frame 11 of the ice maker 10, the user can clean the inside of the storage tank 100 more efficiently.

In addition, since the feeder screw 200 is detachably disposed in the attachment/detachment hole 110 of the storage tank 100, the feeder screw 200 can be detached from the storage tank 100. Since the feeder screw 200 is detachable from the storage tank 100, the user can efficiently clean the underside of the feeder screw 200 in the storage tank 100.

Although the embodiments of the present disclosure have been described as specific embodiments, this is merely an example, and the present disclosure should be construed as having the broadest scope according to the technical idea disclosed herein without being limited thereto. Those skilled in the art may implement a pattern of a shape not indicated herein by combining/substituting the disclosed embodiments, but this also does not deviate from the scope of the present disclosure. In addition, those skilled in the art may easily change or modify the disclosed embodiments based on the present specification, and it is clear that such changes or modifications also fall within the scope of the present disclosure.

1. An ice maker comprising:
a storage tank, disposed inside a main frame, storing ice produced by an ice making unit;
a feeder screw rotatably disposed in the storage tank and conveying the ice by rotation;
a coupler assembly detachably connected to one side of the feeder screw, wherein when rotated in one direction, the coupler assembly is in an engaged state where the coupler assembly is engaged with the one side of the feeder screw, and when rotated in the other direction, the coupler assembly is in a disengaged state where the coupler assembly is not engaged with the one side of the feeder screw; and
a drive motor operated to rotate the coupler assembly in the one direction or the other direction.

2. The ice maker of claim 1, wherein the coupler assembly includes:
a first coupler which is rotated by the drive motor and has a first protrusion/recess formed on an outer peripheral surface thereof; and
a second coupler which has a second protrusion/recess formed on an inner surface thereof to be engaged with the first protrusion/recess of the first coupler, the second coupler being coupled to the first coupler by an engagement between the first protrusion/recess and the second protrusion/recess, and
wherein the first coupler and the second coupler are configured such that the first coupler and the second coupler rotate together, or the first coupler is rotatable in a state where the rotation of the second coupler is restricted.

3. The ice maker of claim 2, further comprising a stopper which is placed in a rotation-restricting position that restricts a rotation of the second coupler or in a rotation-permitting position that permits the rotation of the second coupler,
wherein the second coupler includes a protruding rib that engages with the stopper when the drive motor rotates in the one direction while the stopper is in the rotation-restricting position, and
the rotation of the second coupler is restricted by the engagement between a protruding rib and the stopper while the stopper is in the rotation-restricting position.

4. The ice maker of claim 3, wherein in a state where the coupler assembly is in the disengaged state and the stopper is placed in the rotation-restricting position, when the first coupler is rotated in the one direction, the rotation of the second coupler is restricted by the engagement between the protruding rib and the stopper, and the second coupler is moved along the first coupler to approach the feeder screw, thereby switching the coupler assembly from the disengaged state to the engaged state, and
wherein in a state where the coupler assembly is in the engaged state and the stopper is placed in the rotation-restricting position, when the first coupler is rotated in the other direction, the rotation of the second coupler is restricted by the engagement between the protruding rib and the stopper, and the second coupler is moved along the first coupler away from the feeder screw, thereby switching the coupler assembly from the engaged state to the disengaged state.

5. The ice maker of claim 4, wherein when the coupler assembly is in the engaged state, the coupler assembly rotates in the one direction, thereby causing the feeder screw to discharge the ice to the outside of the storage tank.

6. The ice maker of claim 3, further comprising an opening/closing door configured to open to discharge ice stored in the storage tank to the outside,
wherein the stopper is disposed on the opening/closing door, and
wherein when the opening/closing door is opened, the stopper is placed in the rotation-permitting position.

7. The ice maker of claim 2, wherein the first protrusion/recess has a screw shape extending in a right-hand thread direction or a left-hand thread direction,
the second protrusion/recess has a screw shape engaging with the first protrusion/recess, and
the feeder screw includes a conveying blade having a screw shape extending in a direction opposite to that of the first protrusion/recess.

8. The ice maker of claim 2, wherein the second coupler is formed with a coupler engagement portion having a groove shape, and
the feeder screw includes a screw engagement portion which is formed on the one side and which engages with the coupler engagement portion when the coupler assembly is in the engaging state, thereby preventing relative rotation between the feeder screw and the coupler assembly.

9. The ice maker of claim 8, wherein the screw engagement portion has a shape with narrower width as it extends toward an end, and
the coupler engagement portion has a tapered shape that is inclined outward.

10. The ice maker of claim 1, wherein the storage tank is formed with an attachment/detachment hole in which the feeder screw is selectively fixed,
the feeder screw includes a magnetic body disposed on the other side of the feeder screw, and
the other side of the feeder screw adheres to the storage tank by the magnetic body inserted into the attachment/detachment hole.
